(19) United States
(12) Patent Application Publication
(10) Pub. No.: US 2014/0269963 A1
(43) Pub. Date: Sep. 18, 2014

(54) Diversity Reception and Transmission in LTE Communication Systems

(71) Applicant: BROADCOM CORPORATION, Irvine, CA (US)

(72) Inventors: Rafael CARMON, Rishon Lezion (IL); Sharon Levy, Binyamina (IL); Amir Appel, Kfar-Saba (IL)

(73) Assignee: Broadcom Corporation, Irvine, CA (US)

(21) Appl. No.: 13/833,568

(22) Filed: Mar. 15, 2013

(51) Int. Cl. H04B 7/04

(52) U.S. Cl. CPC H04B 7/0413
USPC 375/267; 375/299; 375/347

(57) ABSTRACT

A communication system is disclosed that includes a communication transmitter that converts various information signals that collectively occupy a large signal bandwidth into various signals that individually occupy small signal bandwidths for transmission to a communication receiver. The communication receiver converts these various signals that individually occupy the small signal bandwidth to recovered information signals that collectively occupy the large signal bandwidth for processing.

### BACKGROUND OF THE DISCLOSURE

1. Field of the Disclosure

The present disclosure relates generally to a communication system, and more specifically to a communication system for adjusting signal bandwidths of information signals between a small signal bandwidth and a large signal bandwidth for transmission over a communication channel.

2. Related Art

Various communication standards, such as an Institute of Electrical and Electronics Engineers (IEEE) 802.16 family of wireless-networks standards, commonly referred to as Worldwide Interoperability for Microwave Access (WiMAX), a third generation (3G) mobile communication standard, a 3GPP Long Term Evolution (LTE) communication standard, and/or a fourth generation (4G) mobile communication standard to provide some examples, allocate their respective assigned frequency spectrum into smaller communication channels. For example, the 4G mobile communication standard is assigned to the 1.8-2.5 GHz and 2-8 GHz frequency spectrum. In this example, the 4G mobile communication standard allocates this frequency spectrum into smaller communication channels having selectable signal bandwidths between approximately 5 MHz and approximately 20 MHz. Various signal processing devices used by various communication devices of the 4G mobile communication standard typically operate at 20 MHz to process signals within these smaller communication channels. While these signal processing devices optimally process signals within the 20 MHz signal bandwidth, they are not optimally used for processing, signals within the 5-MHz signal bandwidth. The present disclosure provides for various processing devices that demultiplex several of these lower signal bandwidth channels to allow for the optimal use of their processing power.

### BRIEF DESCRIPTION OF THE DRAWINGS/FIGURES

The accompanying drawings illustrate the present disclosure and, together with the description, further serve to explain the principles of the disclosure and to enable one skilled in the pertinent art to make and use the disclosure.

FIG. 1 illustrates a block diagram of a communication environment according to an exemplary embodiment of the present disclosure;

FIG. 2 illustrates a block diagram of a communication transmitter according to an exemplary embodiment of the present disclosure;

FIG. 3 illustrates a block diagram of a first front end module that can be implemented as part of the communication transmitter according to an exemplary embodiment of the present disclosure;

FIG. 4 illustrates a block diagram of a second front end module that can be implemented as part of the communication transmitter according to an exemplary embodiment of the present disclosure;

FIG. 5 illustrates a block diagram of a communication receiver according to an exemplary embodiment of the present disclosure;

FIG. 6 illustrates a block diagram of a first front end module that can be implemented as part of the communication receiver according to an exemplary embodiment of the present disclosure; and

FIG. 7 illustrates a block diagram of a second front end module that can be implemented as part of the communication receiver according to an exemplary embodiment of the present disclosure.

The present disclosure will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE DISCLOSURE

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the disclosure. Rather, the scope of the disclosure is defined only in accordance with the following claims and their equivalents.

Embodiments of the disclosure may be implemented in hardware, firmware, software, or any combination thereof. Embodiments of the disclosure may also be implemented as instructions stored on a machine-readable medium, which may be read and executed by processors. A machine-readable medium may include any mechanism for storing or transmitting information in a form readable by a machine (e.g., a computing device). For example, a machine-readable medium may include a non-transitory machine-readable medium, such as read only memory (ROM); random access memory (RAM); magnetic disk storage media; optical storage media; flash memory devices; and others. As another example, the machine-readable medium may include transitory machine-readable medium, such as electrical, optical, acoustical, or other forms of propagated signals (e.g., carrier waves, infrared signals, digital signals, etc.). Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The following Detailed Description of the exemplary embodiments will so fully reveal the general nature of the disclosure that others can, by applying knowledge of those skilled in the relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled it the relevant art(s) in light of the teachings herein.

For purposes of this discussion, the term “module” shall be understood to include at least one of software, firmware, and hardware (such as circuits, microchips, or devices, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

### OVERVIEW

The following Detailed Description describes a communication system having a transmitter that converts various information signals that collectively occupy a large signal bandwidth into various signals that individually occupy small signal bandwidths for transmission to a receiver. The receiver converts these various signals that individually occupy the small signal bandwidth to recovered information signals that collectively occupy the large signal bandwidth for processing.

Exemplary Communication Environment

FIG. 1 illustrates a block diagram of a communication environment according to an exemplary embodiment of the present disclosure. A communication environment 100 is an exemplary representation of a multiple-input and multiple-output (MIMO) communication environment that includes the use of multiple transmit antennas at a communication transmitter 102 and multiple receive antennas at a communication receiver 106. The communication environment 100 includes the communication transmitter 102 to transmit one or more information signals 150 as received from one or more transmitter user devices to the communication receiver 106 via a communication link 104. The one or more transmitter user devices can include, but is not limited to, one or more personal computers, data terminal equipment, one or more telephony devices, one or more broadband media players, one or more personal digital assistants, one or more software applications, or one or more other electronic devices that are capable of transmitting or receiving data.

The communication transmitter 102 provides transmitted communication signals 152.1 through 152.n by operating upon the one or more information signals 150 according to a known communication standard, such as, but not limited to, an Institute of Electrical and Electronics Engineers (IEEE) 802.16 family of wireless-networks standards, commonly referred to as Worldwide Interoperability for Microwave Access (WiMAX), a third generation (3G) mobile communication standard, a 3GPP Long Term Evolution (LTE) communication standard, a fourth generation (4G) mobile communication standard, and/or any other suitable communication standard that will be apparent to those skilled in the relevant art(s) without departing from the spirit and scope of the present disclosure. The one or more information signals 150 can include multiple electronic signals which are multiplexed in time, namely time-division multiplexed (TDM), and/or frequency, namely frequency-division multiplexed (FDM). As such, the transmitted communication signals 152.1 through 152.n can represent time division multiple access (TDMA) communication signals, orthogonal frequency division demultiplexed (OFDM) communication signals, code division multiple access (CDMA) communication signals, any other communication signals that can include orthogonal signaling dimensions, or any combination thereof. Additionally, the transmitted communication signals 152.1 through 152.n can be frequency division duplexed (FDD) and/or time-division duplexed (TDD) with other communication signals within the communication environment 100. In an exemplary embodiment, the communication transmitter 102 can be implemented within the MIMO communication environment. In this exemplary embodiment, the transmitted communication signals 152.1 through 152.n can represent the one or more information signals 150 as being transmitted from multiple transmission antennas. In another exemplary embodiment, the communication transmitter 102 can implement a carrier aggregation scheme. In this other exemplary embodiment, the transmitted communication signals 152.1 through 152.n can represent the one or more information signals 150 having different carrier frequencies. In a further exemplary embodiment, the communication transmitter 102 can implement the carrier aggregation scheme implemented within the MIMO communication environment.

The transmitted communication signals 152.1 through 152.n traverse through the communication link 104 to provide received communication signals 154.1 through 154.m. The transmitted communication signals 152.1 through 152.n can include a similar or a dissimilar number of communication signals as the received communication signals 154.1 through 154.m. In an exemplary embodiment, the communication link 104 can represent information carrying channels and/or control channels of a cellular communication network. For example, the communication link 104 can represent information carrying communication channels of the LTE communication standard, such as a Physical Downlink Shared Channel (PDSC), and/or a Physical Uplink Shared Channel (PUSCH) to provide some examples, control communication channels of the LTE communication standard, such as a Physical Uplink Control Channel (PUCCH), a Physical Downlink Control Channel (PDCCH), a Physical Control Format Indicator Channel (PCFICH), and/or a Physical Hybrid ARQ Indicator Channel (PHICH) to provide some examples, and/or any other suitable communication channel of the LTE communication standard, such as a Random Access Channel (RACH) and/or a sounding reference channel (SRS) to provide some examples.

The communication receiver 106 observes the received communication signals 154.1 through 154.m as they traverse through the communication link 104. In an exemplary embodiment, the communication receiver 106 can be implemented within the MIMO communication environment. In this exemplary embodiment, the received communication signals 154.1 through 154.m can represent the transmitted communication signals 152.1 through 152.n as being observed from multiple receiving antennas. For example, the received communication signals 154.1 through 154.m represent the multiple communication paths traversed by each of the transmitted communication signals 152.1 through 152.n through the communication link 104. For example, the received communication signal 154.1 represents the transmitted communication signals 152.1 through 152.n as they traverse through a first communication path of the communication link 104. Likewise, the received communication signal 154.m represents the transmitted communication signals 152.1 through 152.n as they traverse through an m^{th} communication path of the communication link 104. In another exemplary embodiment, the communication receiver 106 can implement the carrier aggregation scheme. In this other exemplary embodiment, the received communication signals 154.1 through 154.m can represent the transmitted communication signals 152.1 through 152.n having different carrier frequencies as they traverse through the communication link 104. In a further exemplary embodiment, the communication receiver 106 can implement the carrier aggregation scheme implemented within the MIMO communication environment. It should be noted that the communication transmitter 102 and the communication receiver 106 can both be implemented within a base station or access point of a cellular communication network. In this configuration, that the communication transmitter 102 can provide the transmitted communication signals 152.1 through 152.n representing uplink communication signals to one or more mobile stations via an uplink communication channel and the communication receiver 106 can receive the received communication signals 154.1 through 154.m representing downlink communication signals from the one or more mobile stations via a downlink communication channel.

The communication receiver 106 can recover the one or more information signals 150 from the received communication signals 154.1 through 154.m to provide one or more recovered information signals 156 for one or more receiver user devices by operating upon the received communication signals 154.1 through 154.m according to the known communication standard. The receiver user devices can include, but are not limited to, personal computers, data terminal equipment, telephony devices, broadband media players, personal digital assistants, software applications, or any other medium capable of transmitting or receiving data.

In some situations, the communication transmitter 102 and the communication receiver 106 can include multiple transmitting antennas and multiple receiving antennas, respectively, to form the MIMO communication environment. In other situations, the communication transmitter 102 and the communication receiver 106 can include multiple transmitting antennas and a single receiving antenna, respectively, to form a multiple-input and single-output (MISO) communication environment. In yet other situations, the communication transmitter 102 and the communication receiver 106 can include a single transmitting antenna and multiple receiving antennas, respectively, to form a single-input and multiple-output (SIMO) communication environment.

Often times, a governing authority, such as the Federal Communication Commission (FCC) or any other like governing authority, uniquely allocates frequency spectrum for use by the communication environment 100. This frequency spectrum can be further allocated into smaller portions of frequency spectrum, often referred to as communication channels, according to the known communication standard. In some situations, the communication channels can be characterized as having a selectable signal bandwidth. In these situations, it is desirable to have the communication transmitter 102 be capable of operating upon signals having large signal bandwidths, such as approximately 20 MHz to provide an example, and demultiplexing or separating communication signals having the large signal bandwidths to provide signals that have small signal bandwidths, such as approximately 10 MHz to provide an example, for transmission over communication channels that support these smaller signal bandwidths. It is also desirable to have the communication receiver 106 be capable of operating upon signals having the large signal bandwidths and multiplexing or combining communication signals having the small signal bandwidths to provide signals that have the large signal bandwidth for processing. The demultiplexing or separating by the communication transmitter 102 and/or the multiplexing or combining by the communication receiver 106 allows the communication transmitter 102 and/or the communication receiver 106 to advantageously utilize their large signal bandwidth processing capabilities when operating upon signals having smaller signal bandwidths.

Exemplary Communication Transmitter

FIG. 2 illustrates a block diagram of a communication transmitter according to an exemplary embodiment of the present disclosure. A communication transmitter 200 receives the one or more information signals 150 which collectively occupy a large signal bandwidth. After processing the one or more information signals 150, the communication transmitter 200 demultiplexes or separates these processed communication signals to provide the transmitted communication signals 152.1 through 152.n that individually occupy smaller signal bandwidths. The communication transmitter 200 includes a processing module 202, a front end module 204, and transmitting antennas 206.1 through 206.n. The communication transmitter 200 can represent an exemplary embodiment of the communication transmitter 102.

The processing module 202 operates upon the one or more information signals 150 in accordance with a known communication standard, such as, but not limited to, the WiMAX communication standard, the 3G mobile communication standard, the LTE communication standard, the 4G mobile communication standard, and/or any other suitable communication standard that will be apparent to those skilled in the relevant art(s) without departing from the spirit and scope of the present disclosure, to provide a processed information signal 250. Additionally, the processing module 202 can provide various electronic signals that are specified in accordance with the known communication standard as the processed information signal 250. These electronic signals can be multiplexed in time, namely time-division multiplexed (TDM), and/or frequency, namely frequency-division multiplexed (FDM), with the one or more information signals 150.

The front end module 204 demultiplexes or separates the processed information signal 250 to provide transmitted communication signals 254.1 through 254.n. Specifically, the front end module 204 demultiplexes or separates the processed information signal 250 having a large signal bandwidth to provide transmitted communication signals 254.1 through 254.n having small signal bandwidths. The front end module 204 includes an interface module 208 and radio frequency integrated circuits (RFICs) 210.1 through 210.d. The interface module 208 demultiplexes or separates the processed information signal 250, which occupies a large signal bandwidth, such as approximately 20 MHz using a large sampling rate of approximately 30.72 MHz to provide an example, in the analog, signal domain, the digital signal domain, or any combination thereof to provide demultiplexed information signals 252.1 through 252.d. The demultiplexed information signals 252.1 through 252.d individually have a small signal bandwidth, such as approximately 20/d MHz to provide an example. In an exemplary embodiment, the interface module 208 demultiplexes or separates the processed information signal 250 into the demultiplexed information signals 252.1 through 252.2 that individually occupy a signal bandwidth of approximately 10 MHz.

The RFICs 210.1 through 210.d operate on their corresponding demultiplexed information signals 252.1 through 252.d to provide the transmitted communication signals 254.1 through 254.n. The RFICs 210.1 through 210.d can frequency translate or upconvert their corresponding demultiplexed information signals 252.1 through 252.d to a radio frequency (RF) or any other suitable frequency using a suitable upconversion process that will be apparent to those skilled in the relevant art(s). The RFICs 210.1 through 210.d can additionally separate the their corresponding demultiplexed information signals 252.1 through 252.d into corresponding transmitted communication signals 254.1 through 254.n for transmission in the MIMO communication environment and/or a carrier aggregation scheme such as the communication environment 100 to provide an example. The RFICs 210.1 through 210.d can, optionally, convert their corresponding demultiplexed information signals 252.1 through 252.d from a representation in the digital signal domain to a representation in the analog signal domain. The RFICs 210.1 through 210.d can, optionally, modulate and/or encode their corresponding demultiplexed information signals 252.1 through 252.d in accordance with the known communication standard.

The transmitting antennas 206.1 through 206.n provide the transmitted communication signals 152.1 through 152.n to the communication channel. The transmitting antennas 206.1 through 206.n convert the transmitted communication signals 254.1 through 254.n from electromagnetic currents to electromagnetic waves to provide the transmitted communication signals 152.1 through 152.n. Typically, one or more of the transmitting antennas 206.1 through 206.n are coupled to each of the RFICs 210.1 through 210.d. For example, as shown in FIG. 2, a first group of the transmitting antennas 206.1 through 206.n, denoted as transmitting antennas 206.1 through 206.a, is coupled to the RFIC 210.1 from among the RFICs 210.1 through 210.d and a second group of the transmitting antennas 206.1 through 206.n, denoted as transmitting antennas 206.(a+1) through 206.n, is coupled to the RFIC 210.d from among the RFICs 210.1 through 210.d. However, this example is for illustrative purposes only, those skilled in the relevant art(s) will recognize that other configurations and arrangements of the transmitting antennas 206.1 through 206.n are possible without departing from the spirit and scope of the present disclosure. In an exemplary embodiment, the communication transmitter 200 includes the RFICs 210.1 and 210.2, the RFIC 210.1 being coupled to transmitting antennas 206.1 and 206.2 and the RFIC 210.2 being coupled to transmitting antennas 206.3 and 206.4.

First Exemplary Front End Module that can be Implemented as Part of the Exemplary Communication Transmitter

FIG. 3 illustrates a block diagram of a first front end module that can be implemented as part of the communication transmitter according to an exemplary embodiment of the present disclosure. A front end module 300 demultiplexes or separates the processed information signal 250 in a digital signal domain and operates upon these separated information signals to provide the transmitted communication signals 254.1 through 254.4. The front end module 300 includes a digital interface module 302 and RFICs 304.1 and 304.2. The front end module 300 can represent an exemplary embodiment of the front end module 204.

As shown in FIG. 3, the processed information signal 250 includes one or more information signals that collectively occupy a large signal bandwidth, such as approximately 20 MHz to provide an example. The one or more information signals can be allocated to occupy different and/or similar portions of the large signal bandwidth. For example, as shown in FIG. 3, sub signal 1 through sub-signal 8 represent various information signals that occupy different portions of the large signal bandwidth. As another example, the sub-signal 5 through the sub-signal 8 can originate from a similar source such as within the MIMO communication environment to provide an example. The one or more information signals can be multiplexed in time, namely time-division multiplexed (TDM), and/or frequency, namely frequency-division multiplexed (FDM), to occupy the large signal bandwidth. In some situations, a guard band can be used to avoid interference between neighboring sub-signals, such as between sub-signal 1 and sub-signal 4, as shown in FIG. 3.

The digital interface module 302 demultiplexes or separates the processed information signal 250 in the digital signal domain to provide the demultiplexed communication signals 354.1 and 354.2 having small signal bandwidths. The digital interface module 302 includes a digital multiplier 306 and half-band decimation filters 308.1 and 308.2. The digital interface module 302 can represent an exemplary embodiment of the interface module 208.

The digital multiplier 306 frequency translates the processed information signal 250 using a digital local oscillator signal 350 to provide a translated information signal 352. For example, as shown in FIG. 3, the digital multiplier 306 frequency translates the sub-signal 1 through sub-signal 8 of the processed information signal 250 by approximately 15.36 MHz to provide the translated information signal 352.

The half-band decimation filters 308.1 and 308.2 digitally down sample and half band filter the processed information signal 250 to provide the demultiplexed communication signal 354.1 and the translated information signal 352 to provide the demultiplexed communication signal 354.2, respectively. The downsampling of the processed information signal 250 and the translated information signal 352, by the half-band decimation filters 308.1 and 308.2 respectively, effectively down samples and half band filters the processed information signal 250 and the translated information signal 352 from the large signal bandwidths to the small signal bandwidths. For example, as shown in FIG. 3, the half-band decimation filter 308.1 down samples and half band filters the sub-signal 5 through sub-signal 8 of the processed information signal 250 from the large signal bandwidth of approximately 20 sampled at the large sample rate of 30.72 MHz to the small sample rate of approximately 15.36 MHz to provide the demultiplexed communication signal 354.1. As another example, as shown in FIG. 3, the half-band decimation filter 308.2 down samples and half band filters the sub-signal 1 through sub-signal 4 of the translated information signal 352 from the large signal bandwidth of approximately 20 sampled at the large sample rate of 30.72 MHz to the small, sample rate of approximately 15.36 MHz to provide the demultiplexed communication signal 354.2.

The RFICs 304.1 and 304.2 operate on their corresponding demultiplexed communication signals 354.1 and 354.2 to provide the transmitted communication signals 254.1 through 254.4 in a substantially similar manner as the RFICs 210.1 through 210.d.

Second Exemplary Front End Module that can be Implemented as Part of the Exemplary Communication Transmitter

FIG. 4 illustrates a block diagram of a second front end module that can be implemented as part of the communication transmitter according to an exemplary embodiment of the present disclosure. A front end module 400 demultiplexes or separates the processed information signal 250 in an analog signal domain and operates upon these separated information signals to provide the transmitted communication signals 254.1 through 254.4. The front end module 400 includes an analog interface module 402 and RFICs 404.1 and 404.2. The front end module 400 can represent an exemplary embodiment of the front end module 204.

The analog interface module 402 demultiplexes or separates the processed information signal 250 in the analog signal domain to provide the demultiplexed communication signals 450.1 and 450.2 having small signal bandwidths. The analog interface module 402 includes a demultiplexer module 414, separation modules 406.1 through 406.4, packing and multiplexer modules 408.1 through 408.4, and multiplexer modules 410.1 through 410.2. The analog interface module 402 can represent an exemplary embodiment of the interface module 208.

As discussed above, the processed information signal 250 can include one or more information signals that collectively occupy a large signal bandwidth, such as approximately 20 MHz to provide an example. In some situations, each of these one or more information signals can represent quadrature phase information signals that include in-phase (I) components and quadrature phase (Q) components. In an exemplary embodiment, the processed information signal 250 includes two information signals that collectively occupy the large signal bandwidth. In this exemplary embodiment, a first information signal from among the two information signals includes a first I component and a first Q component and a second information signal from among the two information signals includes a second I component and a second Q component. In, this exemplary embodiment, the first information signal can be from a first cell in a cellular network and the second information signal can be from a second, neighboring cell in the cellular network. As such, the first information signal and/or the second information signal can include multiple electronic signals which are multiplexed in time, namely time-division multiplexed (TDM), and/or frequency, namely frequency-division multiplexed (FDM).

The demultiplexer module 414 demultiplexes or separates the processed information signal 250 into I components 452 and Q components 454. From the exemplary embodiment above, the demultiplexer module 414 demultiplexes or separates the first information signal into a first I component 452.1 and a first Q component 454.1 and the second information signal into a second I component 452.2 and a second Q component 454.2.

The separation modules 406.1 through 406.4 further demultiplex or separate their corresponding I components 452 and the Q components 454 into negative components 456 or positive components 458. Each of the separation modules 406.1 through 406.4 is implemented in a substantially similar manner; therefore, only the separation module 406.1 is to be discussed in further detail. The separation module 406.1 demultiplexes or separates the first I component 452.1 into a first negative component 456.1 which represents components of the first I component 452.1 that are less than approximately zero and a second positive component 458.1 which represents components of the first I component 452.1 that are greater than approximately zero. The separation module 406.1 includes a Hilbert filter module 412 and combination modules 414.1 and 414.2.

The Hilbert filter module 412 performs a Hilbert transform upon the first I component 452.1 to shift a phase of all frequency components of the first I component 452.1 by approximately −π/2 radians to provide a transformed component 460. The Hilbert transform, H(f), can be denoted as:

j,f<0,

0,f=0, and

−j,f>0, (1)

where j represents a basic imaginary unit \sqrt{−1} and f represents a frequency component of the first I component 452.1. From the exemplary embodiment above, the first information signal and the second information signal within the processed information signal 250 are substantially equally spread between two sides of the frequency origin allowing the use of the Hilbert transform to clean adjacent, unwanted sides from among the first I component 452.1. In an exemplary embodiment, the Hilbert filter module 412 is implemented with 256 coefficients to ensure the transformed component 460 is sufficiently flat and has sufficient rejection. In some situations, the processed information signal 250 can include one or more guard bands of approximately 15 kHz each to ensure that the Hilbert filter module 412 meets flatness and rejection requirement in accordance with the known communication standard. In these situations, the number of coefficients of the Hilbert filter module 412 is related to the number of guard bands within the processed information signal 250. A fewer number of coefficients requires more guard bands to meet the rejection requirement whereas more coefficients requires less guard bands to meet the rejection requirement. In an exemplary embodiment, the Hilbert filter module 412 is implemented with 126 coefficients and the processed information signal 250 includes 3 guard bands of 15 kHz each to meet the rejection requirement. In this exemplary embodiment, the Hilbert filter module 412 can be implemented in poly-phase with 8 phases of 16 adaptive filter tapes each.

The combination module 414.1 subtracts the transformed component 460 from the first I component 452.1 to provide the first negative component 456.1. Similarly, the combination module 414.2 combines the transformed component 460 and the first I component 452.1 to provide the first positive component 458.1.

The packing and multiplexer modules 408.1 through 408.4 multiplex or combine various similar negative or positive components from among the negative components 456 or positive components 458 in the analog signal domain to provide multiplexed negative components 462 or multiplexed positive components 464. For example, the packing and multiplexer modules 408.1 and 408.3 multiplex or combine the first negative component 456.1 and the second negative component 456.2 to provide a first multiplexed negative component 462.1 and the third negative component 456.3 and the fourth negative component 456.4 to provide a second multiplexed negative component 462.2, respectively. As another example, the packing and multiplexer modules 408.2 and 408.4 multiplex or combine the first positive component 458.1 and the second positive component 458.2 to provide a first multiplexed positive component 464.1 and the third positive component 458.3 and the fourth positive component 458.4 to provide a second multiplexed positive component 464.2, respectively.

From the exemplary embodiment above, the packing and multiplexer module 408.1 multiplexes or combines the first negative component 456.1 representing I components of the first information signal that are less than approximately zero and the second negative component 456.2 representing Q components of the first information signal that are less than approximately zero to provide the first multiplexed negative component 462.1. In this exemplary embodiment, the packing and multiplexer module 408.2 multiplexes of combines the first positive component 458.1 representing I components of the first information signal that are greater than approximately zero and the second positive component 458.2 representing Q components of the first information signal that are greater than approximately zero to provide a first multiplexed positive component 464.1. In this exemplary embodiment, the packing and multiplexer module 408.3 multiplexes or combines the third negative component 456.3 representing I components of the second information signal that are less than approximately zero and the fourth negative component 456.4 representing Q components of the first information signal that are less than approximately zero to provide a second multiplexed negative component 462.2. In this exemplary embodiment, the packing and multiplexer module 408.4 multiplexes or combines the third positive component 458.3 representing I components of the second information signal that are greater than approximately zero and the second positive component 458.4 representing Q components of the second information signal that are greater than approximately zero to provide a second multiplexed positive component 464.2.

The multiplexer modules 410.1 through 410.2 multiplex or combine the first and second multiplexed negative components 462.1 and 462.2 to provide the demultiplexed communication signal 450.1 and the first and the second multiplexed positive components 464.1 and 464.2 to provide the demultiplexed communication signal 450.2, respectively. From the exemplary embodiment above, the demultiplexed communication signal 450.1 includes I and Q components of the first and second information signals that are less than approximately zero that collectively occupy the small signal bandwidth, such as approximately 10 MHz to provide an example. The demultiplexed communication signal 450.2 includes I and Q components of the first and second information signals that are greater than approximately zero that collectively occupy the small signal bandwidth.

The RFICs 404.1 and 404.2 operate on their corresponding demultiplexed communication signals 450.1 and 450.2 to provide the transmitted communication signals 254.1 through 254.2 in a substantially similar manner as the RFICs 210.1 through 210.d; therefore, only differences between the RFICs 404.1 and 404.2 and the RFICs 210.1 through 210.d are to be discussed in further detail below. The RFICs 404.1 and 404.2 can frequency translate or upconvert their corresponding demultiplexed communication signals 450.1 and 450.2 to a radio frequency (RF) or any other suitable frequency using a suitable upconversion process that will be apparent to those skilled in the relevant art(s) using a corresponding local oscillator signal 466.1 and 466.2. In an exemplary embodiment, the local oscillator signal 466.1 is offset approximately −2.25 MHz from a RF carrier frequency while the local oscillator signal 466.2 is offset approximately 2.25 MHz from the RF carrier frequency. In another exemplary embodiment, the local oscillator signal 466.1 is offset approximately −2.295 MHz from a RF carrier frequency while the local oscillator signal 466.2 is offset approximately 2.295 MHz from the RF carrier frequency. The difference in offset of the local oscillator signal 466.1 and the local oscillator signal 466.2 from the RF carrier frequency in these two exemplary embodiments is related to the number of guard bands within the processed information signal 250 which is 3 guard bands of 15 kHz each.

Exemplary Communication Receiver

FIG. 5 illustrates a block diagram of a communication receiver according to an exemplary embodiment of the present disclosure. A communication receiver 500 receives the received communication signals 154.1 through 154.m that individually occupy small signal bandwidths as they traverse through a communication channel. For example, the received communication signals 154.1 through 154.m can represent the transmitted communication signals 152.1 through 152.n as being observed from multiple receiving antennas. In another exemplary embodiment, the communication receiver 106 can implement the carrier aggregation scheme. In this other exemplary embodiment, the received communication signals 154.1 through 154.m can represent the transmitted communication signals 152.1 through 152.n having different carrier frequencies as they traverse through the communication link 104. After processing of the received communication signals 154.1 through 154.m, the communication receiver 500 multiplexes or combines these processed communication signals to provide the one or more recovered information signals 156 which collectively occupy a large signal bandwidth. The communication receiver 500 includes receiving antennas 502.1 through 502.m, a front end module 504, and a processing module 506. The communication receiver 500 can represent an exemplary embodiment of the communication receiver 106.

The receiving antennas 502.1 through 502.m receive the received communication signals 154.1 through 154.m as they traverse through the communication channel. The receiving antennas 502.1 through 502.m convert the received communication signals 154.1 through 154.m from electromagnetic currents to electromagnetic waves to provide the received communication signals 550.1 through 550.4.

The front end module 504 multiplexes or combines the received communication signals 550.1 through 550.4 to provide a multiplexed communication signal 554. Specifically, the front end module 504 multiplexes or combines the received communication signals 550.1 through 550.4 having small signal bandwidths to provide the multiplexed communication signal 554 having a large signal bandwidth. The front end module 504 includes radio frequency integrated circuits (RFICs) 508.1 through 508.e and an interface module 510.

The RFICs 508.1 through 508.e operate on their corresponding received communication signals 550.1 through 550.4 to provide recovered communication signals 552.1 through 552.e. The RFICs 508.1 through 508.e can frequency translate or downconvert their corresponding received communication signals 550.1 through 550.4 to a baseband frequency or any other suitable frequency using a suitable upconversion process that will be apparent to those skilled in the relevant art(s). The RFICs 508.1 through 508.e can, optionally, convert their corresponding received communication signals 550.1 through 550.4 from a representation in the analog signal domain to a representation in the digital signal domain. The RFICs 508.1 through 508.e can, optionally, demodulate and/or decode their corresponding received communication signals 550.1 through 550.4 in accordance with the known communication standard.

Typically, each of the RFICs 508.1 through 508.e is coupled to one or more of the receiving antennas 502.1 through 502.m. For example, as shown in FIG. 5, the RFIC 508.1 is coupled to a first group of the receiving antennas 502.1 through 502.m, denoted as receiving antennas 502.1 through 502.b, from among the receiving antennas 502.1 through 502.m and the RFIC 508.2 is coupled to a second group of the receiving antennas 502.1 through 502.m, denoted as receiving antennas 502.(b+1) through 502.e, from among the receiving antennas 502.1 through 502.m. However, this example is for illustrative purposes only, those skilled in the relevant art(s) will recognize that other configurations and arrangements of the RFICs 508.1 through 508.e are possible without departing from the spirit and scope of the present disclosure. In an exemplary embodiment, the communication receiver 500 includes the RFICs 508.1 and 508.2, the RFIC 508.1 being coupled to receiving antennas 502.1 and 502.2 and the RFIC 508.2 being coupled to receiving antennas 502.3 and 502.4.

The interface module 510 multiplexes or combines the recovered communication signals 552.1 through 552.e which individually occupy small signal bandwidths, such as approximately 20/e MHz to provide an example, in the analog signal domain, the digital signal domain, or any combination thereof to provide the multiplexed communication signal 554. The multiplexed communication signal 554 collectively has a large signal bandwidth, such as approximately 20 MHz to provide an example. In an exemplary embodiment, the interface module 510 multiplexes or combines the recovered communication signals 552.1 through 552.e into the multiplexed communication signal 554 that collectively occupies a signal bandwidth of approximately 20 MHz using a sample rate of approximately 30.72 MHz.

The processing module 506 operates upon the multiplexed communication signal 554 in accordance with the known communication standard to provide the one or more recovered information signals 156.

First Exemplary Front End Module that can be Implemented as Part of the Exemplary Communication Receiver

FIG. 6 illustrates a block diagram of a first front end module that can be implemented as part of the communication receiver according to an exemplary embodiment of the present disclosure. A front end module 600 processes the received communication signals 550.1 through 550.4 and multiplexes or combines these processed signals in a digital signal domain, to provide the multiplexed communication signal 554. The front end module 600 includes RFICs 602.1 and 602.2 and a digital interface module 604. The front end module 600 can represent an exemplary embodiment of the front end module 504.

The RFICs 602.1 and 602.2 operate on their received communication signals 550.1 through 550.4 to provide recovered communication signals 650.1 and 650.2 in a substantially similar manner as the RFICs 508.1 through 508.e. The recovered communication signals 650.1 and 650.2 include one or more information signals that individually occupy small signal bandwidths, such as approximately 10 MHz to provide an example. The one or more information signals can be allocated to occupy different and/or similar portions of the large signal bandwidth. For example, as shown in FIG. 6, sub-signal 1 through sub-signal 8 represent various information signals that occupy different portions of the small signal bandwidth. The one or more information signals can be multiplexed in time, namely time-division multiplexed (TDM), and/o frequency, namely frequency-division multiplexed (FDM), to occupy the large signal bandwidth.

The digital interface module 604 multiplexes or combines the recovered communication signals 650.1 and 650.2 in the digital signal domain to provide the multiplexed communication signal 554 having the large signal bandwidth. The digital interface module 604 includes half-band interpolation filters 606.1 and 606.2, a digital multiplier 608, and a combination module 610. The digital interface module 604 can represent an exemplary embodiment of the interface module 510.

The half-band interpolation filters 606.1 and 606.2 digitally upsample and half band filter the recovered communication signals 650.1 and 650.2 provide up-sampled communication signals 652.1 and 652.2. The upsampling of the recovered communication signals 650.1 and 650.2 by the half-band interpolation filters 606.1 and 606.2 effectively upsamples and half band filters the recovered communication signals 650.1 and 650.2 from the small signal bandwidths to the large signal bandwidths. For example, as shown in FIG. 6, the half-band interpolation filter 606.1 up samples and half band filters the sub-signal 5 through sub-signal 8 of the recovered communication signals 650.1 from the small signal bandwidth of approximately 10 MHz sampled at a small sample rate of approximately 15.36 MHz to a large sample rate of approximately 30.72 MHz to provide the up-sampled communication signal 652.1. As another example, as shown in FIG. 6, the half-band interpolation filter 606.2 up samples and half band filters the sub-signal 1 through sub-signal 4 of the recovered communication signals 650.2 from the small sample rate of approximately 15.36 MHz to the large sample rate of approximately 30.72 MHz to provide the up-sampled communication signal 652.2.

The digital multiplier 608 frequency translates the up-sampled communication signal 652.1 using a digital local oscillator signal 654 to provide a translated communication signal 656. For example, as shown in FIG. 6, the digital multiplier 608 frequency translates the sub-signal 5 through sub-signal 8 of the up-sampled communication signal 652.1 by approximately 15.36 MHz to provide the translated communication signal 656.

The combination module 610 combines the up-sampled communication signal 652.1 and the translated communication signal 656 to provide the multiplexed communication signal 554. For example, as shown in FIG. 6, the combination module 610 combines the sub-signal 5 through sub-signal 8 of the translated communication signal 656 with the sub-signal 1 through 4 of the up-sampled communication signal 652.2.

Second Exemplary Front End Module that can be Implemented as Part of the Exemplary Communication Receiver

FIG. 7 illustrates a block diagram of a second front end module that can be implemented as part of the communication receiver according to an exemplary embodiment of the present disclosure. A front end module 700 multiplexes or combines the received communication signals 550.1 through 550.4 in an analog signal domain to provide the multiplexed communication signal 554. The front end module 700 includes RFICs 702.1 and 702.2 and an analog interface module 704. The front end module 700 can represent an exemplary embodiment of the front end module 504.

The RFICs 702.1 and 702.2 operate on their received communication signals 550.1 through 550.4 to provide recovered communication signals 750.1 and 750.2 in a substantially similar manner as the RFICs 508.1 through 508.e; therefore, only differences between the RFICs 508.1 through 508.e and the RFICs 702.1 and 702.d are to be discussed in farther detail below. The RFICs 702.1 and 702.2 can frequency translate or downconvert their corresponding from received communication, signals 550.1 through 550.4 from a radio frequency (RF) to baseband or any other suitable frequency using a suitable downconversion process that will be apparent to those skilled in the relevant art(s) using a corresponding local oscillator signal 752.1 and 752.2. In an exemplary embodiment, the local oscillator signal 752.1 is offset approximately −2.25 MHz from a RF carrier frequency while the local oscillator signal 752.2 is offset approximately 2.25 MHz from the RF carrier frequency. In another exemplary embodiment, the local oscillator signal 752.1 is offset approximately −2.295 MHz from a RF carrier frequency while the local oscillator signal 752.2 is offset approximately 2.295 MHz from the RF carrier frequency. The difference in offset of the local oscillator signal 752.1 and the local oscillator signal 752.2 from the RF carrier frequency in these two exemplary embodiments is related to the number of guard bands within the received communication signals 550.1 through 550.4 which are 3 guard bands of 15 kHz each.

The analog interface module 702 multiplexes or combines the recovered communication signals 750.1 and 750.2 that individually occupy small signal bandwidths in the analog signal domain to provide the multiplexed communication signal 554 that occupies the large signal bandwidth. The analog interface module 704 includes demultiplexer modules 706.1 and 706.2, combination modules 708.1 through 708.4, and a multiplexer module 710. The analog interface module 704 can represent an exemplary embodiment of the interface module 410.

As discussed above, the received communication signals 550.1 through 550.4 can include one or more information signals that individually occupy small signal bandwidths, such as approximately 10 MHz to provide an example. In some situations, each of these one or more information signals can represent quadrature phase information signals that include in-phase (I) components and quadrature phase (Q) components. In an exemplary embodiment, the received communication signals 550.1 through 550.4 include two information signals that individually occupy the small signal bandwidth. In this exemplary embodiment, a first information signal from among the two information signals includes a first I component and a first Q component and a second information signal from among the two information signals includes a second I component and a second Q component. In this exemplary embodiment, the first information signal can be from a first cell in a cellular network and the second information signal can be from a second, neighboring cell in the cellular network. As such, the first information signal and/or the second information signal can include multiple electronic signals which are multiplexed in time, namely time-division multiplexed (TDM), and/or frequency, namely frequency-division multiplexed (FDM).

The demultiplexer modules 706.1 and 706.2 demultiplexes their corresponding recovered communication signals 750.1 and 750.2 into negative components 754.1 through 754.4 and positive components 756.1 through 756.4, respectively. The negative components 754.1 through 754.4 represent components of the recovered communication signals 750.1 that are less than approximately zero and the positive components 756.1 through 756.4 represent components of the recovered communication signals 750.2 that are greater than approximately zero. The negative components 754.1 through 754.4 and the positive components 756.1 through 756.4 individually occupy the small signal bandwidth, such as approximately 10 MHz to provide an example.

The combination modules 708.1 through 708.4 multiplex or combine various similar negative and positive components from among the negative components 754 or positive components 756 in the analog signal domain to provide multiplexed signal components 758.1 through 758.4. From the exemplary embodiment above, the combination module 708.1 multiplexes or combines the negative component 754.1 and the positive component 756.1 to provide the multiplexed signal component 758.1 which represents the first I component of the first information signal from among the two information signals. Also from the exemplary embodiment above, the combination module 708.2 multiplexes or combines the negative component 754.2 and the positive component 756.2 to provide the multiplexed signal component 758.2 which represents the first Q component of the first information signal from among the two information signals. Further from the exemplary embodiment above, the combination module 708.3 multiplexes or combines the negative component 754.3 and the positive component 756.3 to provide the multiplexed signal component 758.3 which represents the second I component of the second information signal from among the two information signals. Yet further from the exemplary embodiment above, the combination module 708.4 multiplexes or combines the negative component 754.4 and the positive component 756.4 to provide the multiplexed signal component 758.4 which represents the second Q component of the second information signal from among the two information signals.

The multiplexer module 710 multiplexes or combines the multiplexed signal components 758.1 through 758.4 to provide the multiplexed communication signal 554. From the exemplary embodiment above, the multiplexed signal components 758.1 through 758.4 includes I and Q components of the first and second information signals that are less than approximately zero that collectively occupy the small signal bandwidth, such as approximately 10 MHz to provide an example. The multiplexed communication signal 554 includes I and Q components of the first and second information signals that collectively occupies the large signal bandwidth.

### CONCLUSION

It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It will be apparent to those skilled in the relevant art(s) that various changes in form and detail can be made therein without departing from the spirit and scope of the disclosure. Thus the disclosure should not be limited by any of the above-described exemplary embodiments, but should be defined only in accordance with the following claims and their equivalents.

What is claimed is:

1. A communication system, comprising:
a communication transmitter configured to process an information signal that occupies a first signal bandwidth to provide a plurality of transmitted communication signals that individually occupy a second signal bandwidth, the second signal bandwidth being less than the first signal bandwidth; and
a communication receiver configured to observe the plurality of transmitted communication signals as they pass through a communication channel to provide a plurality of received communication signals that individually occupy the second signal bandwidth and to process the plurality of received communication signals to provide a recovered information signal that occupies the first signal bandwidth.

2. The communication system of claim 1, wherein the communication transmitter is further configured to process the information signal in a digital signal domain, and
wherein the communication receiver is further configured to process the plurality of received communication signals in the digital signal domain.

3. The communication system of claim 1, wherein the communication transmitter is further configured to process the information signal in an analog signal domain, and
wherein the communication receiver is further configured to process the plurality of received communication signals in the analog signal domain.

4. The communication system of claim 1, wherein the communication transmitter is further configured to separate the information signal into a plurality of separated information signals, each of the plurality of separated information signals occupying the second signal bandwidth, and to upconvert the plurality of separated information signals to provide the plurality of transmitted communication signals.

5. The communication system of claim 1, wherein the communication receiver is further configured to downconvert the plurality of received communication signals to provide a plurality of recovered communication signals, each of the plurality of recovered communication signals occupying the second signal bandwidth, and to combine the plurality of recovered communication signals to provide the recovered information signal.

6. The communication system of claim 1, wherein the communication transmitter comprises:
an interface configured to separate the information signal into a plurality of separated information signals; and
a plurality of radio frequency integrated circuits, each of the plurality of radio frequency integrated circuits being configured to operate upon a corresponding one of the plurality of separated information signals to provide a corresponding one of the plurality of transmitted communication signals.

7. The communication system of claim 1, wherein the communication receiver comprises:
a plurality of radio frequency integrated circuits, each of the plurality of radio frequency integrated circuits being configured to operate upon a corresponding one of the plurality of received communication signals to provide a corresponding one of a plurality of recovered communication signals; and
an interface configured to combine the plurality of recovered communication signals to provide the recovered information signal.

8. A communication transmitter, comprising:
an interface configured to separate an information signal that occupies a first signal bandwidth to provide a plurality of separated information signals that individually occupy a second signal bandwidth that is less than the first signal bandwidth; and
a plurality of radio frequency integrated circuits, each of the plurality of radio frequency integrated circuits being configured to operate upon a corresponding one of the plurality of separated information signals to provide a corresponding one of a plurality of transmitted communication signals.

9. The communication transmitter of claim 8, further comprising:
a plurality of transmitting antennas coupled to each of the plurality of radio frequency integrated circuits, the plurality of transmitting antennas being configured to provide the corresponding one of the plurality of transmitted communication signals.

10. The communication transmitter of claim 8, wherein the interface comprises:
a first half-band decimation filter configured to downsample the information signal from a first sample rate to a second sample rate that is less than the first sample rate to provide a first separated information signal from among the plurality of separated information signals;
a digital multiplier configured to multiply the information signal in accordance with a digital oscillator to provide a translated information signal; and
a second half-band decimation filter configured to downsample the translated information signal from the first sample rate to the second sample rate to provide a second separated information signal from among the plurality of separated information signals.

11. The communication transmitter of claim 10, wherein a first radio frequency integrated circuit from among the plurality of radio frequency integrated circuits is configured to operate upon the first separated information signal to provide a first transmitted communication signal from among the plurality of transmitted communication signals, and
wherein a second radio frequency integrated circuit from among the plurality of radio frequency integrated circuits is configured to operate upon the second separated information signal to provide a second transmitted communication signal from among the plurality of transmitted communication signals.

12. The communication transmitter of claim 8, wherein the interface comprises:
a demultiplexer configured to demultiplex the information signal into a plurality of quadrature components;
a plurality of separation modules configured to separate the plurality of quadrature components into a plurality of positive components and a plurality of negative components;
a plurality of packing and multiplexer modules configured to combine each of the plurality of negative components with a corresponding one of the plurality of negative components to provide a plurality of multiplexed negative components and to combine each of the plurality of positive components with a corresponding one of the plurality of positive components to provide a plurality of multiplexed positive components;
a plurality of multiplexer modules configured to combine the plurality of multiplexed negative components to provide a first separated information signal from among the plurality of separated information signals and to combine the plurality of multiplexed positive components to provide a second separated information signal from among the plurality of separated information signals.

13. The communication transmitter of claim 12, wherein at least one of the plurality of separation modules comprises:
a Hilbert filter configured to operate upon a corresponding one of the plurality of quadrature components to provide a transformed component;
a first combination module configured to subtract the corresponding one of the plurality of quadrature components from the transformed component to provide at least one corresponding first component form among the plurality of positive components or the plurality of negative components; and
a second combination module configured to combine the corresponding one of the plurality of quadrature components from the transformed component to provide at least one corresponding second component form among the plurality of positive components or the plurality of negative components.

14. The communication transmitter of claim 12, wherein a first radio frequency integrated circuit from among the plurality of radio frequency integrated circuits is configured to operate upon the first separated information signal in accordance with a first local oscillator signal to provide a first transmitted communication signal from among the plurality of transmitted communication signals,
wherein a second radio frequency integrated circuit from among the plurality of radio frequency integrated circuits is configured to operate upon the second separated information signal in accordance with a second local oscillator signal to provide a second transmitted communication signal from among the plurality of transmitted communication signals, and
wherein the first local oscillator signal is offset from the second local oscillator signal.

15. A communication receiver, comprising:
a plurality of radio frequency integrated circuits configured to operate upon a plurality of communication signals to provide a plurality of recovered communication signals, each of the plurality of communication signals individually occupying a first signal bandwidth; and
an interface configured to combine the plurality of recovered communication signals to provide a multiplexed communication signal that collectively occupies a second signal bandwidth that is greater than the first signal bandwidth.

16. The communication receiver of claim 15, further comprising:
a plurality of receiving antennas coupled to each of the plurality of radio frequency integrated circuits, the plurality of receiving antennas being configured to receive the plurality of communication signals.

17. The communication receiver of claim 15, wherein a first radio frequency integrated circuit from among the plurality of radio frequency integrated circuits is configured to operate upon a first communication signal from among the plurality of communication signals in accordance with a first local, oscillator signal to provide a first received communication signal from among the plurality of recovered communication signals,
wherein a second radio frequency integrated circuit from among the plurality of radio frequency integrated circuits is configured to operate upon a second communication signal from among the plurality of communication signals in accordance with a second local oscillator signal to provide a second received communication signal from among the plurality of recovered communication signals, and
wherein the first local oscillator signal is offset from the second local oscillator signal.

18. The communication receiver of claim 17, wherein the interface comprises:
a first half-band interpolation filter configured to up-sample the first received communication signal from a first sample rate to a second sample rate that is greater than the first sample rate to provide a first up-sampled communication signal from among a plurality of up-sampled communication signals;
a second half-band interpolation filter configured to up-sample the second received communication signal from the first sample rate to the second sample rate to provide a second up-sampled communication signal from among a plurality of up-sampled communication signals;
a digital multiplier configured to multiply the first up-sampled communication signal in accordance with a digital oscillator to provide a translated communication signal; and
a combination module configured to combine the first up-sampled communication signal and the translated communication signal to provide the multiplexed communication signal.

19. The communication receiver of claim 15, wherein the interface comprises:
a first demultiplexer configured to separate a first recovered communication signal from among the plurality recovered communication signals to provide a first plurality of quadrature components;
a second demultiplexer configured to separate a second recovered communication signal from among the plurality of recovered communication signals to provide a second plurality of quadrature components;
a plurality of combination modules configured to combine each of the first plurality of quadrature components with a corresponding one of the second plurality of quadrature components to provide a plurality of multiplexed signal components; and
a multiplexer configured to combine the plurality of multiplexed signal components to provide the multiplexed communication signal.

20. The communication receiver of claim 15, wherein the first signal bandwidth is approximately 10 MHz and the second signal bandwidth is approximately 20 MHz.
